(19) United States
(12) Patent Application Publication
(10) Pub. No.: US 2011/0051962 A1
(43) Pub. Date: Mar. 3, 2011

(54) SURROUND SOUND AUDIO CHAIR

(76) Inventor: MARK BENJAMIN COCHRAN, GRANGER, IN (US)

(21) Appl. No.: 12/851,783

(22) Filed: Aug. 6, 2010

Related U.S. Application Data
(60) Provisional application No. 61/237,547, filed on Aug. 27, 2009.

(51) Int. Cl. H04R 5/02

(52) U.S. Cl. 381/301

(57) ABSTRACT

An audio chair includes a plurality of speakers and a sound absorbing material. The audio chair may be designed with an egg-shaped body resting on a pedestal. The egg-shaped body may include a hollow region under the seat. A subwoofer may be mounted in this hollow region, while speakers may be mounted around the sides of the inside of the egg-shaped body. The audio chair may provide 5.1 surround sound, 7.1 surround sound, or standard stereo (2.1) sound in the space within the egg-shaped body with very little sound being delivered outside of the audio chair.

### CROSS-REFERENCE TO RELATED APPLICATIONS

This application claims the benefit of priority to U.S. provisional patent application No. 61/237,547, filed Aug. 27, 2009, which is herein incorporated by reference in its entirety.

### BACKGROUND OF THE INVENTION

The present invention relates to an audio chair and, more particularly, to an audio chair delivering surround sound to a user occupying the audio chair.

Conventional audio chairs have poor bass response. When watching movies, listening to music or playing video games, for example, a person may wish to hear adequate sounds, including a powerful bass response. These people watching movies, listening to music or playing video games may also wish to enjoy the movie or game at a volume that may disturb others around him or her.

As can be seen, there is a need for an audio chair that may provide high quality audio to an occupant of the chair without disturbing others in the vicinity of the chair.

### SUMMARY OF THE INVENTION

In one aspect of the present invention, an audio chair comprises a hollow egg-shaped seating section; a hollow base supporting the seating section; a subwoofer positioned in the hollow base; and a plurality of speakers positioned about an inside of the hollow egg-shaped seating section.

In another aspect of the present invention, an audio chair comprises a enclosed seating section having an open front; an acoustic material lining the inside of the enclosed seating section; a hollow base supporting the seating section; a subwoofer positioned in the hollow base; and a plurality of speakers positioned about an inside of the seating section.

In a further aspect of the present invention, an audio chair comprises an egg-shaped enclosed seating section having an open front; an acoustic material lining the inside of the enclosed seating section; a hollow base supporting the seating section; a subwoofer positioned in the hollow base; and at least five speakers positioned about an inside of the seating section.

These and other features, aspects and advantages of the present invention will become better understood with reference to the following drawings, description and claims.

### BRIEF DESCRIPTION OF THE DRAWINGS

FIG. 1 is a perspective view of an audio chair according to an embodiment of the present invention;

FIG. 2 is a front view of the audio chair of FIG. 1;

FIG. 3 is a top view of the audio chair of FIG. 1;

FIG. 4 is a side view of the audio chair of FIG. 1;

FIG. 5 is a schematic diagram showing a speaker configuration for use in the audio chair, according to an embodiment of the present invention;

FIG. 6 is a schematic diagram showing another speaker configuration for use in the audio chair, according to another embodiment of the present invention;

FIG. 7 is a schematic diagram showing a further speaker configuration for use in the audio chair, according to a further embodiment of the present invention; and

FIG. 8 is an audio response curve showing the audio response from within the audio chair of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an audio chair containing a plurality of speakers and a sound absorbing material. The audio chair may be designed with an egg-shaped body resting on a pedestal.

The egg-shaped body may include a hollow region under the seat. A subwoofer may be mounted in this hollow region, while speakers may be mounted around the sides of the inside of the egg-shaped body. The audio chair may provide 5.1 surround sound, 7.1 surround sound, or standard stereo (2.1) sound in the space within the egg-shaped body with very little sound being delivered outside of the audio chair.

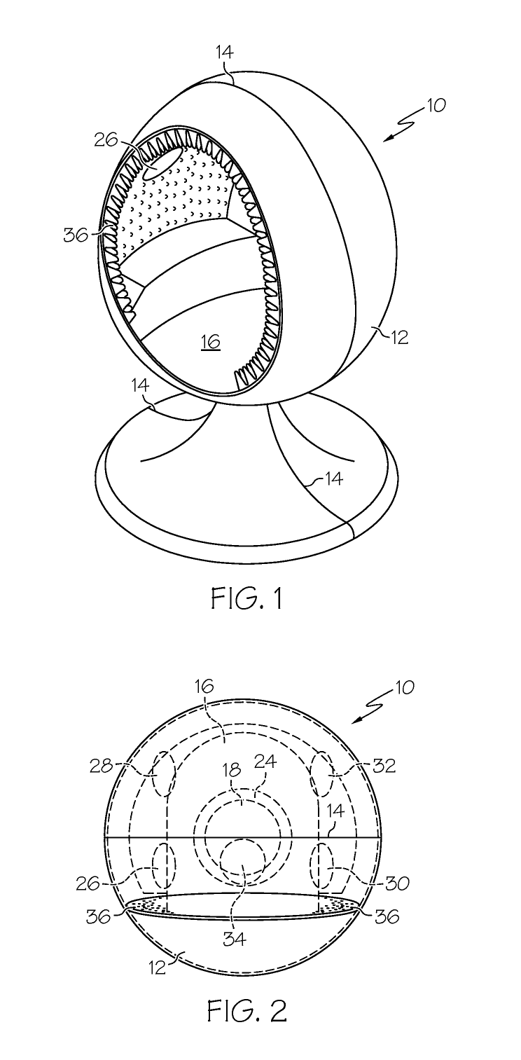

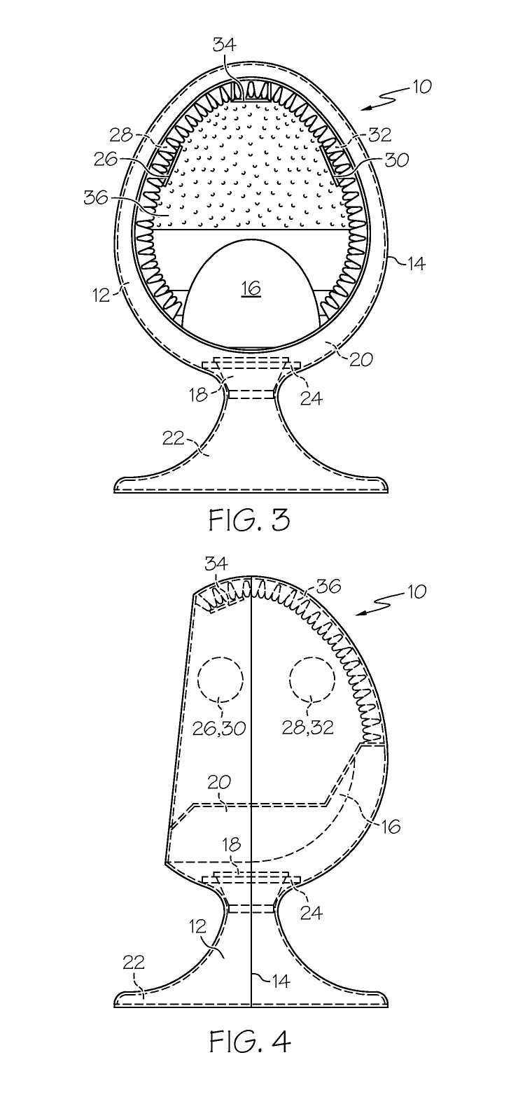

Referring to FIGS. 1 through 4, an audio chair 10 may include an egg-shaped body 12 attached to a pedestal 22. The egg-shaped body 12 may be hollow and may include therewithin, a seat 16, acoustical material 36, and a plurality of speakers. The acoustical material 36 may be an acoustical foam attached to the inside of the egg-shaped body 12 adapted to reduce or eliminate noise reflections within egg-shaped body 12. In one embodiment, the acoustical material 36 may be an open cell acoustical foam.

The speakers may include left and right front speakers 26, 30, left and right rear speakers 28, 32, a center front speaker 34 and a subwoofer 18. The speakers 26, 28, 30, 32 may be mounted approximately at ear level of a user positioned inside the egg-shaped body 12. The configuration shown in FIGS. 1 through 4 may provide a 5.1 surround sound audio system. Two additional speakers (not shown) may be added inside the egg-shaped body 12 to provide a 7.1 surround sound audio system. In an alternate embodiment, either the 5.1 surround sound configuration or the 7.1 surround sound configuration may be adapted to receive a typical stereo input, resulting in a 2.1 audio configuration.

The subwoofer 18 may be mounted in a hollow region 20 formed from a portion of the egg-shaped body 12 and the pedestal 22. A plurality of speaker supports 24 may be used to attach the subwoofer 18 to the egg-shaped body 12. The hollow region 20 may be integral to a hollow region in the pedestal 22. The hollow pedestal 22 may provide a back cavity for the subwoofer 18.

The wiring (not shown) for the speakers may be mounted under the acoustical material 36 and may exit the back of the chair 10 at binding posts (not shown). The binding posts may receive input from a surround sound receiver. Alternatively, in a 2.1 audio configuration, as described below, stereo connectors (such as a ⅛ inch stereo plug, a ¼ inch stereo plug, RCA connectors, or the like) may be provided to receive a stereo audio input.

The audio chair 10 may provide a user the ability to experience loud high fidelity audio sounds in a small space with very little noise being heard outside of the chair 10.

The egg-shaped body 12 and the pedestal 22 may be made, for example, by a process of rotational molding. In one embodiment, the audio chair 10 may be made from two halves joined together at a part line 14.

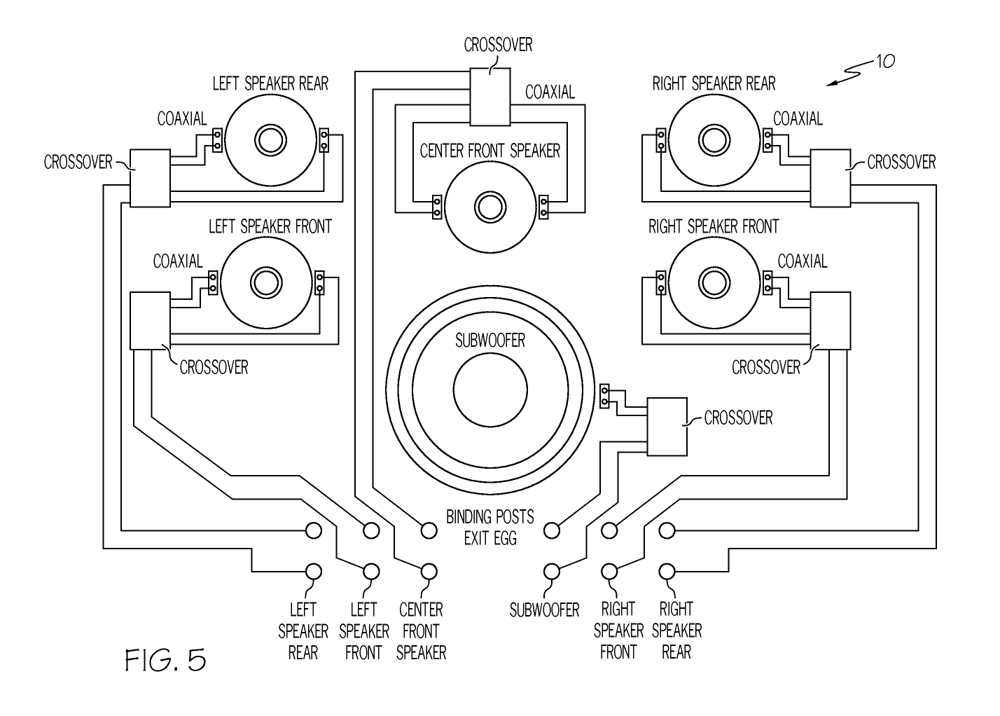

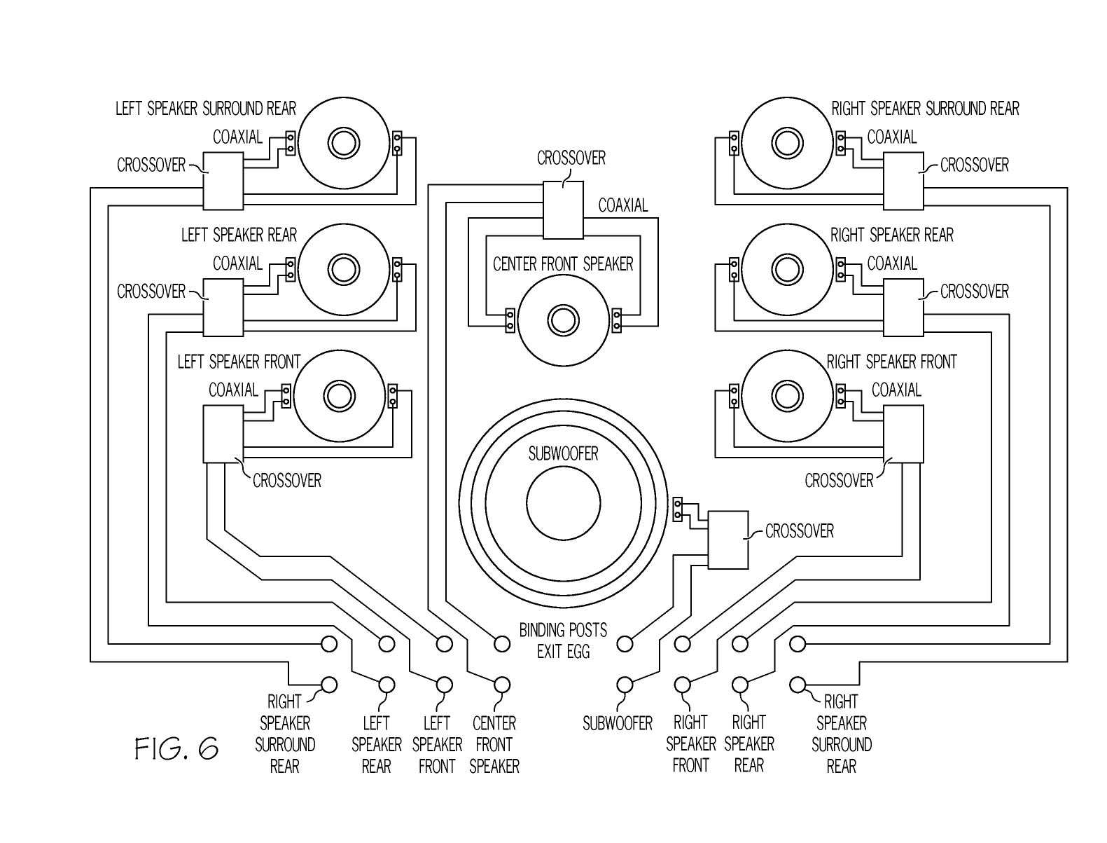

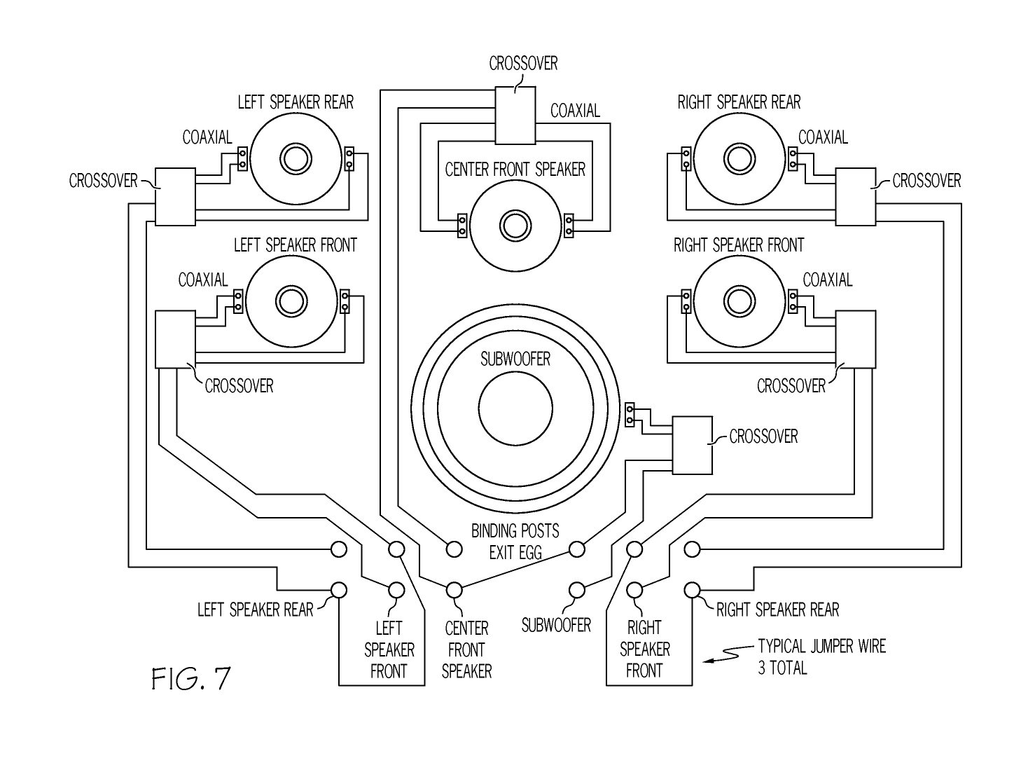

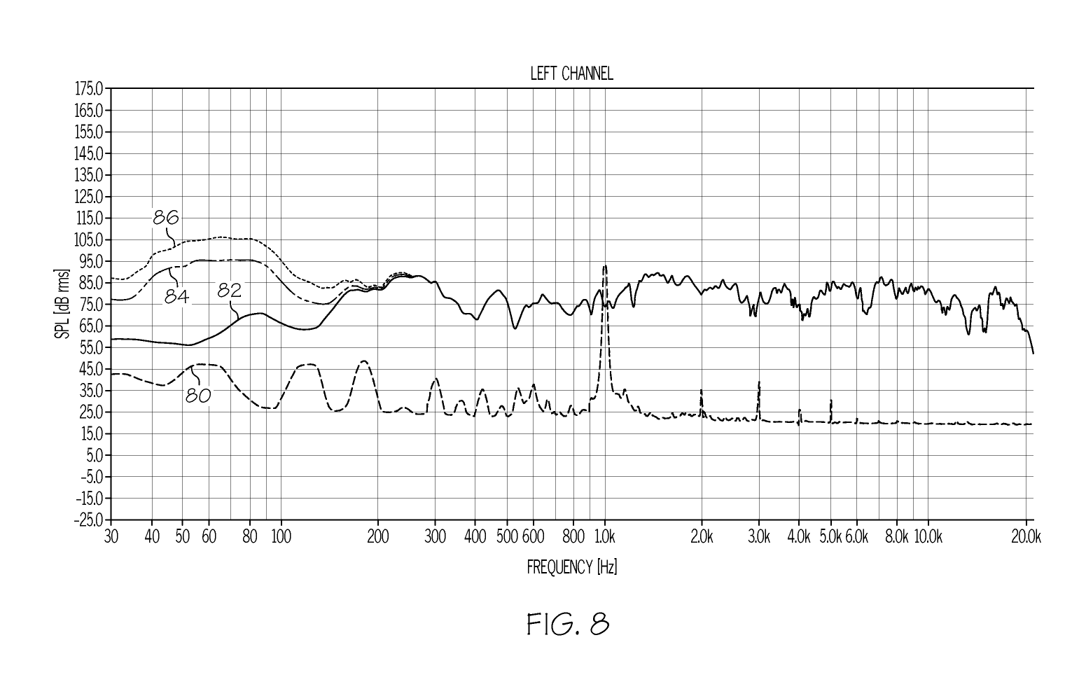

Referring to FIG. 5, a schematic diagram is shown describing the wiring diagram for the speakers in a 5.1 surround sound system. FIG. 6 shows a schematic diagram for wiring the speakers in a 7.1 surround sound system. FIG. 7 shows a schematic diagram for adapting a 5.1 surround sound system into a stereo (2.1) audio system. In each of these configurations, the wiring may include components, such as crossovers and binding posts, as is known in the art.

FIG. 8 is a graph showing frequency response (sound pressure level (SPL), in decibels (dB) versus frequency, in Hertz (Hz)) graph of a plurality of signals. A first signal 80 is of a reference signal at 1000 Hz. A second signal 82 is a white noise signal with no subwoofer, as measured at a typical listening location within the audio chair 10. A third signal 84 is a standard white noise signal measured from within the audio chair 10. The fourth signal 86 is a bass-maximized white noise signal taken measured from within the audio chair 10. As can be seen, there is an excellent bass response by using the audio chair 10 according to an embodiment of the present invention. More specifically, the addition of the subwoofer 18, as mounded in the audio chair 10 as described above, results in a substantial improvement in the bass response. For example, the bass response achieved by using the under seat subwoofer, as described above, may be from about 50 to about 150 percent, typically about 100 percent, better than the bass response without the under seat subwoofer. As shown in FIG. 8, at about 60 Hz, the SPL without the subwoofer is about 47 dB. However, in the audio chair 10, including the subwoofer 18, the SPL at about 60 Hz is about 95 dB.

While the audio chair 10 has been described for use improving the sound of a user listening to music, watching television or a movie, or playing a video game, other uses are within the scope of the present invention. For example, the audio chair 10 may be used to demonstrate active noise reduction headsets, wherein a user may test a noise reduction headset while providing surround sound background noise.

While the audio chair 10 has been described above as egg-shaped, other shapes may be within the scope of the present invention. For example, the audio chair may include any shape enclosed seating section having an open front. For example, the seating section may have a circular, oval or ellipsoidal shape.

It should be understood, of course, that the foregoing relates to exemplary embodiments of the invention and that modifications may be made without departing from the spirit and scope of the invention as set forth in the following claims.

What is claimed is:

1. An audio chair comprising:
a hollow egg-shaped seating section;
a hollow base supporting the seating section;
a subwoofer positioned in the hollow base; and
a plurality of speakers positioned about an inside of the hollow egg-shaped seating section.

2. The audio chair of claim 1, further comprising an acoustic material lining the inside of the hollow egg-shaped seating section.

3. The audio chair of claim 1, wherein the subwoofer is mounted on speaker supports connected to the hollow egg-shaped seating section.

4. The audio chair of claim 1, wherein the plurality of speakers include at least one left rear speaker, at least one right rear speaker, at least one left front speaker, at least one right front speaker and a center front speaker.

5. The audio chair of claim 4, wherein the speakers are adapted to provide 5.1 surround sound.

6. The audio chair of claim 4, further comprising a first and second left rear speaker and a first and second right rear speaker.

7. The audio chair of claim 5, wherein the speakers are adapted to provide 7.1 surround sound.

8. The audio chair of claim 4, wherein the speakers are wired to permit a stereo input.

9. The audio chair of claim 8, wherein the speakers are adapted to provide 2.1 stereo sound.

10. The audio chair of claim 2, wherein the acoustic material is an open cell acoustical foam.

11. The audio chair of claim 1, further comprising a removable seat in the seating area.

12. An audio chair comprising:
a enclosed seating section having an open front;
an acoustic material lining the inside of the enclosed seating section;
a hollow base supporting the seating section;
a subwoofer positioned in the hollow base; and
a plurality of speakers positioned about an inside of the seating section.

13. The audio chair of claim 12, wherein the seating section is egg-shaped.

14. The audio chair of claim 12, wherein in the plurality of speakers include at least 5 speakers positioned about the inside of the seating section.

15. The audio chair of claim 12, further comprising a removable seat adapted to fit within the enclosed seating section.

16. The audio chair of claim 12, wherein a bass response is from about 50 to about 150 percent stronger than the bass response of the audio chair without the subwoofer.

17. An audio chair comprising:
An egg-shaped enclosed seating section having an open front;
an acoustic material lining the inside of the enclosed seating section;
a hollow base supporting the seating section;
a subwoofer positioned in the hollow base; and
at least five speakers positioned about an inside of the seating section.

18. The audio chair of claim 17, wherein the at least five speakers are wired to accept a stereo audio input.

19. The audio chair of claim 17, including seven speakers positioned about the inside of the seating section.

20. The audio chair of claim 17, wherein the speakers produce a surround sound effect inside the audio chair.
